(19) United States
(12) Patent Application Publication
(10) Pub. No.: US 2007/0239468 A1
(43) Pub. Date: Oct. 11, 2007

(54) AUTOMATED GLOBAL CALCULATION OF COMPENSATION AMOUNTS

(75) Inventors: Yolanda M. O'Brien, Hudson, WI (US); Joonhyuk Lee, Woodbury, MN (US); Pablo M. Luchsinger Newton, St. Paul, MN (US); Marjorie H. Rew, Roseville, MN (US); Mikael A. Wegelius, Woodbury, MN (US); Leslie A. Ferry, St. Paul, MN (US); Mary K. Passenheim, Apple Valley, MN (US); Vidhya Vasudevan, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/276,913

(22) Filed: Mar. 17, 2006

(51) Int. Cl. G06Q 10/00; G06F 15/02; G06Q 30/00

(52) U.S. Cl. 705/1; 705/9; 705/14

(57) ABSTRACT

A computerized system is described for automatically calculating compensation amounts for an employee of a corporation based on a set of compensation rules for the country of employment of the employee. A system administrator establishes sets of compensation rules for a plurality of countries by defining compensation types within each of the countries. The computerized system maintains the sets of compensation rules. Upon receiving a profile change request for the employee from a user, e.g., a manager, the computerized system retrieves the set of compensation rules associated with the country of employment of the employee and calculates compensation amounts for the employee. In this way, compensation amounts for the employee may be automatically calculated regardless of the country of employment of the employee. The compensation amounts may include compensation allocation amounts for each compensation type applied to the employee and a total cash compensation amount.

### TECHNICAL FIELD

The invention relates to calculation of employee compensation amounts.

### BACKGROUND

Corporations are subject to compensation rules that specify allocation of a total cash compensation amount for employees of the corporation. The set of compensation rules applied for a given employee depends on the country in which the employee works as well as a labor agreement, a collective agreement, a tariff, a union to which the employee belongs, or similar labor regulations. The sets of compensation rules may comprise legal standards of compensation within the specific country, such as base pay and seniority pay. Additionally, the rules may comprise standards of compensation within the specific country, such as profit sharing and vacation pay. Labor unions, labor agreements and tariffs may have a large impact on the creation and maintenance of compensation rules for a given country.

Compensation rules vary widely between different countries for a given corporation. For example, the set of compensation rules for the United States of America for the corporation may have six compensation types including base salary, hourly base, management objective, profit sharing, profit sharing stock, and sales incentive. However, Italy may have over forty compensation types within its set of compensation rules, and France may have approximately ninety compensation types within its set of compensation rules. In addition, different countries may treat similar compensation types differently. Therefore, the compensation rules of many countries are too complex to conform to existing manager self-service automatic computerized compensation systems and continue to meet the legal standards of compensation for the countries.

In a conventional system, a manager hires a new employee, promotes the employee, or gives the employee a change in compensation and informs the human resources (HR), personnel department, or third party vendor for the corporation of the desired change. The HR, personnel department, or third party vendor then manually determines the compensation allocation amounts for the employee based on the set of compensation rules associated with the country of employment of the employee. The compensation types applied to the employee may change based on at least one of a job grade, a step within the job grade, a salary plan, or position information, such as an override of the employee, within the corporation.

This approach does not allow for manager self-service, and requires involvement by the HR, personnel department, or third party vendor. Furthermore, manually determining compensation amounts for employees residing in different countries is time consuming. Manually determining compensation amounts may also result in calculation errors due to the high complexity of the compensation rules and the treatment of the compensation rules in different countries.

### SUMMARY

In general, the invention relates to a computerized system for automatically calculating compensation amounts for an employee of a corporation based on a set of compensation rules for the country of employment of the employee. A system administrator establishes sets of compensation rules for a plurality of countries by defining compensation types within each of the countries. The computerized system maintains the sets of compensation rules. Upon receiving a profile change request for the employee from a user, e.g., a manager, the computerized system retrieves the set of compensation rules associated with the country of employment of the employee and calculates compensation amounts for the employee. In this way, compensation amounts for the employee may be automatically calculated regardless of the country of employment of the employee. The compensation amounts may include compensation allocation amounts for each compensation type applied to the employee and a total cash compensation amount.

In one embodiment, a computer-implemented method comprises maintaining sets of compensation rules for a plurality of countries in a database for a corporation, receiving a profile change request for an employee of the corporation, and retrieving a set of compensation rules from the database for the country of employment of the employee based on the profile change request. The computer-implemented method further includes automatically calculating compensation amounts for the employee based on the profile change request and the set of compensation rules.

In another embodiment, a computer-implemented system comprises a compensation rules database that maintains compensation rules for a plurality of countries for a corporation, and a user interface module that presents a user interface to a user and receives a profile change request for an employee of the corporation from the user via the user interface. The computer-implemented system also includes a calculation module that retrieves a set of compensation rules from the database for the country of employment of the employee based on the profile change request, and automatically calculates a compensation amount for the employee based on the profile change request and the set of compensation rules.

In a further embodiment, a computer-implemented method comprises receiving compensation rule setup information for a plurality of countries, establishing sets of compensation rules for the plurality of countries based on the setup information, and maintaining the sets of compensation rules for the plurality of countries in a database for a corporation.

In another embodiment, a computer-implemented method comprises receiving a profile change request for an employee of a corporation. The method also comprises automatically calculating a total cash compensation amount for the employee based on the profile change request, and automatically calculating compensation allocation amounts for the employee based on the total cash compensation amount and a set of compensation rules for a country of employment of the employee.

In a further embodiment, a computer-implemented system comprises a user interface module that presents a user interface to a user and receives a profile change request for an employee of a corporation from the user via the user interface. The system also comprises a calculation module that automatically calculates a total cash compensation amount for the employee based on the profile change request, and automatically calculates compensation allocation amounts for the employee based on the total cash compensation amount and a set of compensation rules for a country of employment of the employee.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary computing environment in which a compensation calculation system provides centralized management of employee compensation data for a corporation.

FIG. 2 is a block diagram illustrating the compensation calculation system from FIG. 1 in greater detail.

FIG. 3 is a flowchart illustrating an exemplary process of calculating compensation amounts for an employee of a corporation in accordance with an embodiment of the invention.

FIG. 4 is a flowchart illustrating the process of calculating compensation allocation amounts for each compensation type applied to the employee in greater detail.

FIG. 5 is a flowchart illustrating an exemplary process of establishing sets of compensation rules for a plurality of countries in accordance with an embodiment of the invention.

FIGS. 6-11 and 14 are exemplary screen shots of a user interface presented to a system administrator via a user device.

FIGS. 12 and 13 are exemplary screen shots of a user interface presented to a manager, supervisor or other self-service initiator via a user device.

### DETAILED DESCRIPTION

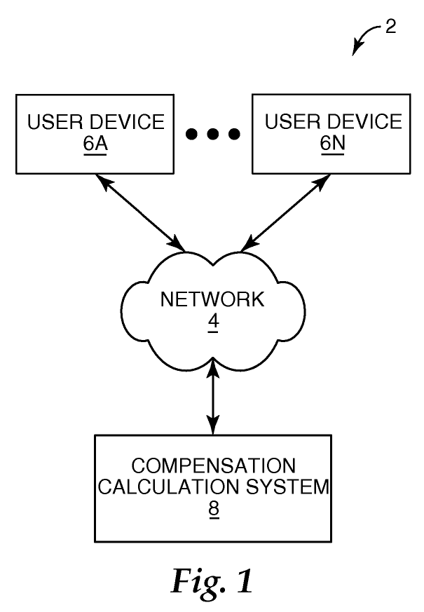

FIG. 1 is a block diagram illustrating an exemplary computing environment 2 in which a compensation calculation system 8 provides centralized management of employee compensation data for a corporation. More specifically, compensation calculation system 8 automatically calculates compensation amounts for employees of the corporation based on a set of compensation rules for the country of employment of the employee. Computer environment 2 also includes a network 4 and a plurality of user devices 6A-6N (“user devices 6”). Users, such as system administrators, managers, supervisors, or other self-service initiators of the corporation, may access compensation calculation system 8 through network 4 via user devices 6. For purposes of illustration, the users will be referred herein to as either administrators or managers.

Network 4 may comprise a private network, such as an intranet for the corporation, or a public network, such as the Internet. Each of user devices 6 may access calculation compensation system 8 via network 4 using suitable communication software such as a web browser. User devices 6 may comprise desktop computers, laptops, workstations, personal digital assistants (PDAs), wireless devices, or other devices. User devices 6 may be included within one or more local area network (LANs) or a wide area network (WANs). For example, user devices 6 may be located at several remote sites of the corporation. In another example, a user (e~g., a system administrator or a manager of the corporation) may remotely access compensation calculation system 8 via the Internet from one of user devices 6 located within their home or another location.

As described in more detail below, compensation calculation system 8 maintains sets of compensation rules for a plurality of countries in a database of the corporation. Compensation calculation system 8 also maintains profile information for a plurality of employees of the corporation. The profile information may include current job grade information and compensation information for each of the plurality of employees.

Compensation calculation system 8 presents a user interface, such as a graphical user interface (GUI) or a web-based user interface, to users via user devices 6. Compensation calculation system 8 may present the user interface as a graphical set of interrelated screens that allow system administrators to create, retrieve, or update the sets of compensation rules. Compensation calculation system 8 may also present the user interface as a graphical set of interrelated screens that allow managers to create, retri eve, or update the profile information for an employee. For example, compensation calculation system 8 may receive compensation rule setup information from the system administrator of the corporation via the user interface presented on one of user devices 6. Compensation calculation system 8 may then establish the sets of compensation rules for the plurality of countries based on the received setup information.

As another example, compensation calculation system 8 may receive a profile change request for an employee from the manager of the employee via the user interface presented on one of user devices 6. When an employee is hired, the manager may enter a profile change request into compensation calculation system 8 to create new profile information for the employee. When an employee moves job grades or receives a raise, the manager may enter a profile change request into compensation calculation system 8 to change existing profile information for the employee.

Upon receiving a profile change request for an employee, compensation calculation system 8 retrieves the set of compensation rules associated with the country of employment of the employee. Compensation calculation system 8 then calculates compensation amounts for the employee based on the profile change request and the set of compensation rules. In this way, compensation calculation system 8 may automatically calculate compensation amounts for the employee regardless of the country of employment of the employee. The compensation amounts may include compensation allocation amounts and a total cash compensation amount for the employee.

Compensation calculation system 8 enables manager self-service such that compensation amounts may be determined for an employee without involving the human resources (HR), personnel department, or third party vendor for the corporation. Furthermore, compensation calculation system 8 reduces resource consumption and calculation errors compared to conventional manual compensation calculation techniques.

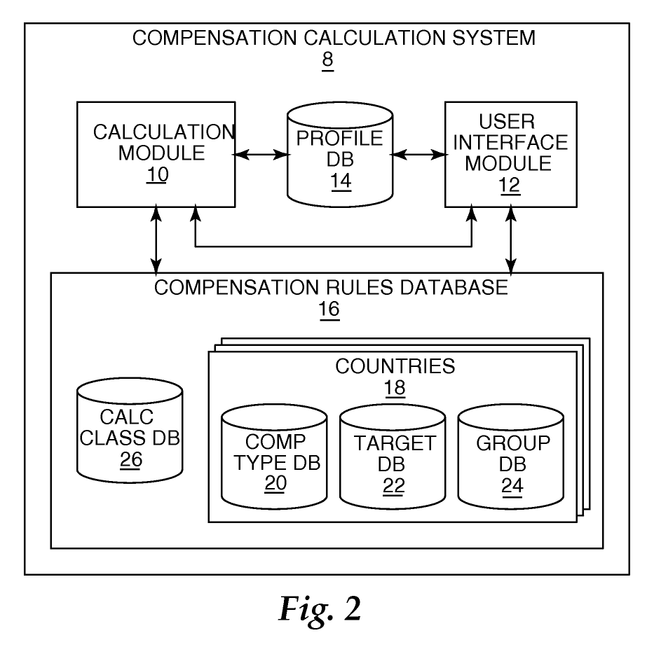

FIG. 2 is a block diagram illustrating compensation calculation system 8 from FIG. 1 in greater detail. As illustrated in FIG. 1, compensation calculation system 8 is connected to user devices 6 via network 4. Network 4 may comprise a corporate network such that users (e.g., system administrators and managers) within the corporation may access compensation calculation system 8 through network 4 via user devices 6. Compensation calculation system 8 includes a calculation module 10, a user interface module 12, a profile database 14 and a compensation rules database 16.

Profile database 14 maintains profile information for a plurality of employees of the corporation. The profile information may include job information and compensation information for each of the plurality of employees. For example, the job information may specify a status, i.e., full-time or part-time, a job grade, a salary plan, and a position title of the employee. In some cases, the compensation information for the employee may be associated with the job grade and/or step within the job grade of the employee. The compensation information may specify a total cash compensation amount for the employee. In some cases, the compensation information may specify a change of the total cash compensation amount for the employee as either a change percentage or a change amount from an existing total cash compensation amount for the employee, or as a new total cash compensation amount.

Compensation rules database 16 maintains sets of compensation rules for a plurality of countries 18 of the corporation. Each of countries 18 includes a compensation type database 20, a target database 22, and a group database 24. Compensation type database 20 stores a plurality of compensation types of the one of countries 18. The compensation types may comprise legal standards of compensation within the specific one of countries 18, such as base pay and seniority pay. Additionally, the compensation types may comprise practice standards of compensation within the specific one of countries 18, such as profit sharing and vacation pay.

Countries 18 may comprise the United States of America, Canada, Mexico, Chile, France, Spain, Portugal, Germany, Italy, China, Japan, and other countries. Each of countries 18 may comprise drastically different compensation rules for a given corporation. For example, the set of compensation rules for the United States of America for the corporation may have six compensation types including base salary, hourly base, management objective, profit sharing, profit sharing stock, and sales incentive. However, Italy may have over forty compensation types within its set of compensation rules, and France may have approximately ninety compensation types within its set of compensation rules. In addition, each of countries 18 may treat similar compensation types differently.

Target database 22 within each of countries 18 stores a plurality of target classes for the one of countries 18. Each of the plurality of target classes comprises a percentage of a total cash compensation amount. Also, each of the plurality of target classes may comprise a share based target class. Each of the plurality of target classes that is share based includes one or more target allocation amounts. In the case of a share based target class, each of the target allocation amounts comprises a share amount within the share based target class.

Group database 24 within each of countries 18 stores a plurality of groups for the one of countries 18. Each of the plurality of groups includes one or more compensation types from the compensation type database 20 of the specific one of countries 18. In some cases, a group may be defined as adding two or more different compensation types together. In other cases, a group may be defined as subtracting one or more compensation types from the total cash compensation amount for the employee. The compensation amount calculated for a specific group stored within group database 24 may be used to calculate compensation allocation amounts for each of the one or more compensation types associated with the specific group.

Compensation rules database 16 also includes a calculation class database 26 that stores a set of calculation classes for all of countries 18. The set of calculation classes defines calculation types applicable to the compensation types stored in compensation type database 20 for each of countries 18. In this way, the large number of different compensation types for all of countries 18 may be classified into a relatively small number of calculation classes based on how the compensation types are calculated. For example, the set of calculation classes may include a fixed by employee class, a fixed class, a target class, a percent of target class, a percent of group class, a residual class, a reserved variable class, and a blank class. In some cases, a calculation class may include several levels to define an order for different compensation types assigned to the same calculation class.

User interface module 12 presents a user interface to a user, such as a system administrator or a manager, via a user device (e.g., one of user devices 6 from FIG. 1). The user interface may comprise a graphical user interface (GUI) or a web-based user interface. User interface module 12 may present profile information and calculated compensation amounts for an employee of the corporation via the user interface. User interface module 12 may also receive information from the users via the user interface. User interface module 12 may present the user interface as a graphical set of interrelated screens that allow the users to create, retrieve, or update compensation rules stored in compensation rules database 16 and profile information stored in profile database 14.

User interface module 12 may receive compensation rule setup information from the system administrator of the corporation via the user interface. Compensation calculation system 8 may then establish the sets of compensation rules for each of countries 18 based on the received compensation rule setup information and store the sets of compensation rules in compensation rules database 16. For example, compensation calculation system 8 may define the plurality of compensation types, define the plurality of target classes and target allocation amounts, and create the plurality of groups for each of countries 18 based on the compensation rule setup information. Compensation calculation system 8 may then assign one or more of the compensation types stored in compensation type database 20 for a specific one of countries 18 to each of a plurality of job grades, steps within job grades, salary plans, or position information, such as position overrides of the employee, in the corporation.

Compensation calculation system 8 may also create the set of calculation classes for all of countries 18 based on the received compensation rule setup information. Some of the compensation types may comprise static calculation types such as a fixed amount of the total cash compensation amount for the employee. In addition, some of the compensation types may comprise dynamic calculation types such a percentage of the total cash compensation amount for the employee or a percentage of a subset of the total cash compensation amount for the employee.

User interface module 12 may also receive a profile change request for an employee from a manager of the employee via the user interface. For example, when a new employee is hired, user interface module 12 may receive a profile change request for the employee and create new entry in profile database 14 to store the profile information for the employee. When an existing employee is promoted or given a raise, user interface module 12 may receive a profile change request for the employee and store the modified profile information for the employee in profile database 14.

Upon receiving a profile change request for an employee, calculation module 10 retrieves the set of compensation rules associated with the country of employment of the employee from compensation rules database 16 based on the profile change request. Calculation module 10 then calculates compensation amounts for the employee based the received profile change request and the retrieved set of compensation rules. In this way, calculation module 10 may automatically calculate compensation amounts for the employee regardless of the country of employment of the employee. The compensation amounts include compensation allocation amounts by compensation type and a total cash compensation amount.

Calculation module 10 calculates the compensation amounts for the employee by selecting one or more of the plurality of compensation types from the compensation type database for the retrieved set of compensation rules. The selected compensation types may depend on at least one of a job grade, a step within the job grade, a salary plan, or position information, such as position overrides, of the employee. In this way, when an employee moves job grades within the corporation, the compensation types applied to the employee change automatically.

Calculation module 10 then determines a calculation class from the set of calculation classes stored in calculation class database 26 for each of the selected compensation types. Some of the compensation types may comprise assigned calculation classes. In addition, certain criteria may allow some of the compensation types to comprise blank calculation classes. In that case, calculation module 10 detects a calculation type for the compensation type and assigns one of the non-blank calculation classes to the compensation type. Calculation module 10 calculates a total cash compensation amount based on a profile change request for the employee. Calculation module 10 then calculates compensation allocation amounts for each of the selected compensation types based on the total cash compensation amount and the determined calculation class for the compensation type. In some cases, a calculation class may include several levels such that calculation module 10 may calculate a compensation allocation amount for different compensation types assigned to the same calculation class in an order defined by the levels.

In some cases, calculation module 10 may sum the compensation allocation amounts and compare with the total cash compensation amount for the employee. If the compensation allocation sum does not equal the total cash compensation amount, calculation module 10 may alter the total cash compensation amount and re-calculate the compensation allocation amounts based on the new total cash compensation amount. In addition, calculation module 10 may compare newly calculated guaranteed compensation allocation amounts to existing guaranteed compensation allocation amounts for the employee. If the newly calculated guaranteed compensation allocation amounts are less than the existing guaranteed compensation allocation amounts, calculation module 10 may alter the new guaranteed compensation allocation amounts to at least match the existing guaranteed compensation allocation amounts.

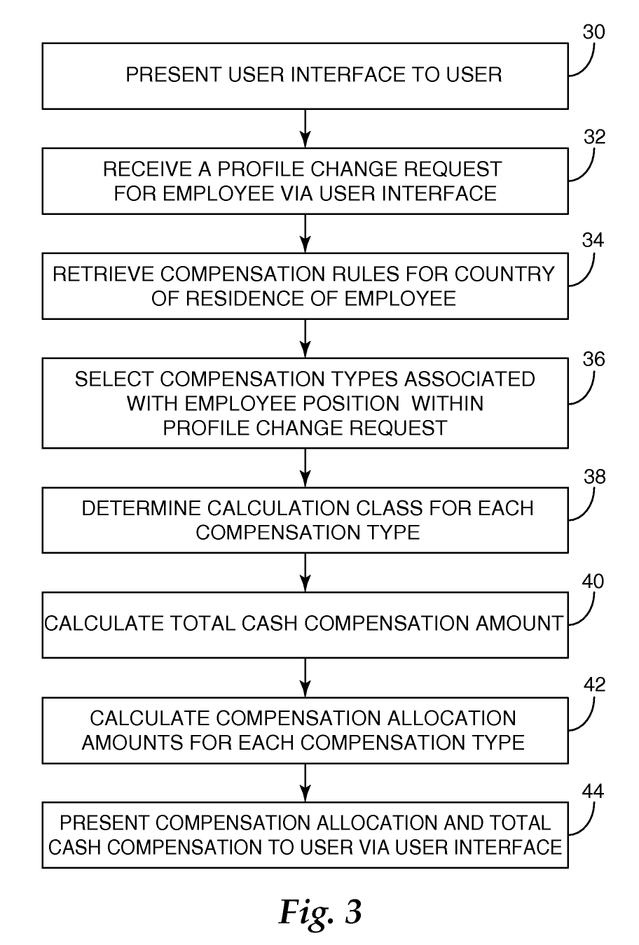

FIG. 3 is a flowchart illustrating an exemplary process of calculating compensation amounts for an employee of a corporation in accordance with an embodiment of the invention. The process will be described herein in reference to compensation calculation system 8 from FIG. 2. User interface module 12 presents a user interface to a user (30). For example, user interface module 12 may present the user interface to a manager of the corporation via a user device (e.g., one of user device 6 from FIG. 1).

User interface module 12 may present any existing profile information stored in profile database 14 for the employee to the manager via the user interface. In exchange, user interface module 12 receives a profile change request for the employee from the manager via the user interface (32). In the case of a GUI or web-based user interface, the user may enter the profile change request for the employee into graphical input boxes presented on the user device. The profile change request may include new profile information or changes to the existing profile information for the employee. User interface module 12 may then temporarily store the received profile change request in profile database 14.

Upon receiving the profile change request, calculation module 10 retrieves a set of compensation rules for the country of employment of the employee from compensation rules database 16 (34). Calculation module 10 selects one or more compensation types stored in compensation type database 20 of the retrieved set of compensation rules based on at least one of a job grade, a step within the job grade, a salary plan, or position information of the employee (36). Calculation module 10 then determines a calculation class for each of the selected compensation types (38).

Calculation module 10 calculates a total cash compensation amount for the employee based on the received profile change request (40). Calculation module 10 then calculates compensation allocation amounts for each of the compensation types based on the assigned calculation class (42). The compensation allocation amounts may be calculated in a specific order based on the calculation classes assigned to the associated compensation types. For example, the compensation allocation amounts may be calculated for the compensation types in the following order: blank classes, fixed by employee classes, fixed amount classes, target classes, percent of target classes, percent of group classes, residual classes, and reserved variable classes.

In some cases, calculation module 10 may calculate a compensation allocation amount for one or more fixed sales incentive compensation types selected from compensation type database 20 by allocating borrowed or rented compensation amounts. Calculation module 10 may then track the borrowed compensation amounts to create fixed sales incentives for the employee and adjust the borrowed compensation amounts based on changes to a total compensation amount of the employee.

In some cases, calculation module 10 may sum the compensation allocation amounts and compare with the total cash compensation amount for the employee. If the compensation allocation sum does not equal the total cash compensation amount, calculation module 10 may alter the total cash compensation amount. In addition, calculation module 10 may compare newly calculated guaranteed compensation allocation amounts to existing guaranteed compensation allocation amounts. If the newly calculated guaranteed compensation allocation amounts are less than the existing guaranteed compensation allocation amounts, calculation module 10 may alter the new guaranteed compensation allocation amounts to at least match the existing guaranteed compensation allocation amounts.

Calculation module 10 may update the calculated compensation amounts in profile information for the employee stored in profile database 14. User interface module 12 may then present the calculated compensation allocation amounts and total cash compensation amounts to the manager via the user interface (44).

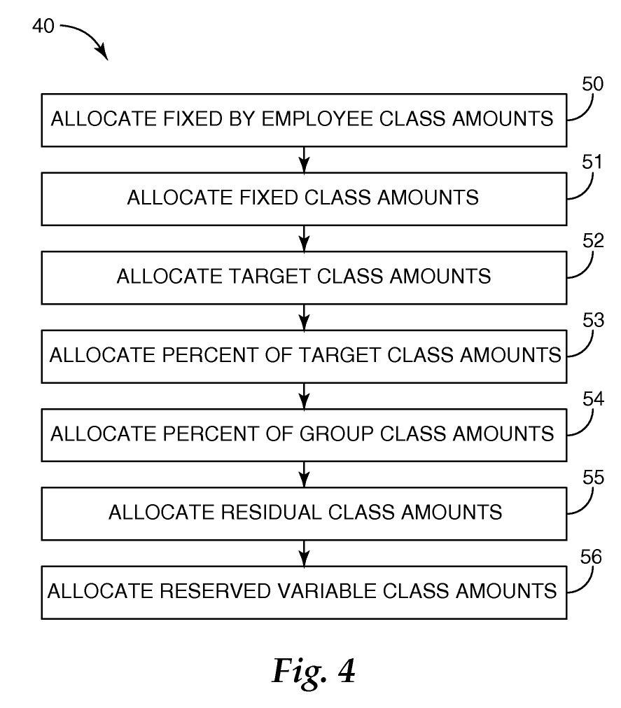

FIG. 4 is a flowchart illustrating the process of calculating compensation allocation amounts for each compensation type applied to the employee (step 40 from FIG. 3) in greater detail. The process will be described herein in reference to compensation calculation system 8 from FIG. 2. As described above, the compensation allocation amounts may be calculated in a specific order based on the calculation classes assigned to the associated compensation types. For each of the compensation types with a blank calculation class, calculation module 10 detects a calculation type for the compensation type and assigns one of the non-blank calculation classes to the compensation type.

Calculation module 10 then allocates fixed by employee class amounts from the total cash compensation amount specified in the profile change request for the employee (50). Fixed by employee class amounts may comprise compensation allocation amounts that are fixed for a specific employee and may be different for each employee within the corporation. For example, fixed by employee class amounts may comprise flat rate seniority pay which may increase based on the amount of time an employee has worked for the corporation. Another example may be a compensation amount given to existing employees employed as of certain date, for which new employees are not eligible. This compensation amount may then be assigned a fixed by employee calculation class.

Calculation module 10 then allocates fixed class amounts from the total cash compensation amount for the employee (51). Fixed class amounts comprise compensation allocation amounts that are a set amount of the total cash compensation amount. For example, a fixed class amount may comprise base pay or vacation pay. Calculation module 10 next allocates target class amounts from the total cash compensation amount for the employee (52). Target class amounts comprise compensation allocation amounts that are percentages of the total cash compensation amount. For example, target class amounts may comprise sales bonus amounts. Calculation module 10 then allocates percent of target class amounts from the target class amounts (53). Percent of target class amounts comprise compensation allocation amounts that when added together with one or more other percent of target compensation allocation amounts are a percentage of the total cash compensation amount. For example, target allocation amounts may comprise a sales bonus amount that is divided into two pieces, the target sales bonus and a legally required amount that when added together make up a percent of the total cash compensation amount.

Calculation module 10 next allocates percent of group class amounts from the total cash compensation amount for the employee (54). Group amounts comprise compensation allocation amounts of one or more compensation types within a group. Percent of group class amounts comprise compensation allocation amounts that are percentages of the group amounts. Calculation module 10 then allocates residual class amounts from the total cash compensation amount for the employee (55). Residual class amounts comprise the total compensation amount less all other previously allocated compensation amounts.

Finally, calculation module 10 allocates reserved variable class amounts from the total cash compensation amount for the employee (56). Reserved variable class amounts comprise compensation allocation amounts that are stored in an account for the employee. For example, when an employee moves from a job grade that includes a sales incentive to a job grade that does not include a sales incentive the excess compensation is assigned a reserved variable calculation class. The excess compensation is then stored in an account for the employee until the employee moves to another job grade that again includes a sales incentive.

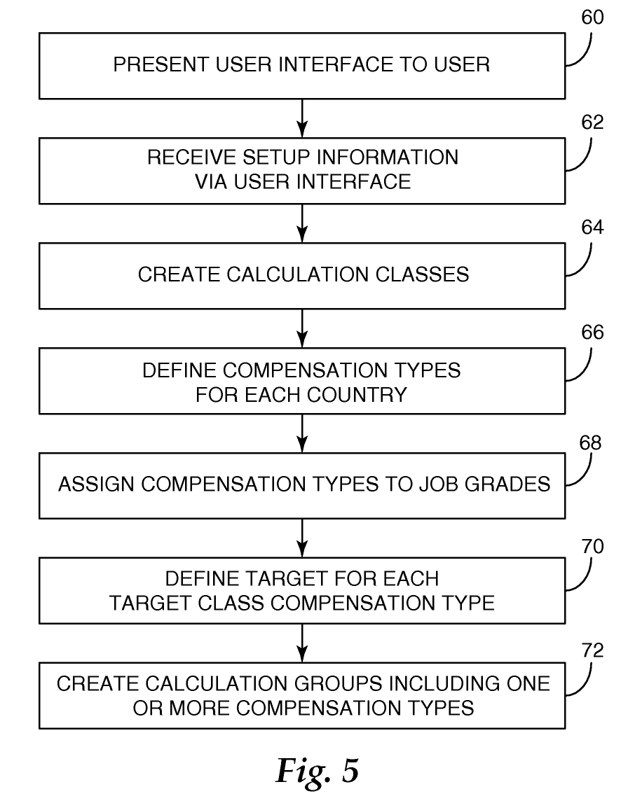

FIG. 5 is a flowchart illustrating an exemplary process of establishing sets of compensation rules for a plurality of countries in accordance with an embodiment of the invention. The process will be described herein in reference to compensation calculation system 8 from FIG. 2. User interface module 12 presents a user interface to a user (60). For example, user interface module 12 may present the user interface to a system administrator of the corporation via a user device (e.g., one of user device 6 from FIG. 1).

User interface module 12 receives compensation rule setup information from the system administrator via the user interface (62). In the case of a GUI or web-based user interface, the user may enter the setup information for the compensation rules into graphical input boxes presented on the user device. Compensation calculation system 8 creates one or more calculation classes based on the received setup information and stores the one or more calculation classes in calculation class database 26 within compensation rules database 16 (64).

Compensation calculation system 8 then defines one or more compensation types for each of countries 18 based on the received setup information (66). The one or more defined compensation types may then be stored in compensation rule database 20 of the associated one of countries 18. According to the setup information received from the system administrator, compensation calculation system 8 then assigns one or more of the compensation types to each of at least one of a job grade, a step within the job grade, a salary plan, or position information within the corporation via user interface (68). In this way, when an employee moves job grades, for example, within the corporation, the compensation types and compensation allocation amounts applied to the employee change automatically.

Compensation calculation system 8 defines one or more target allocation amount for each target class that is share based, based on the received setup information (70). If the target class is share based, the target allocation amount of each share based target class may be stored in target database 22 of the associated one of countries 18. Finally, compensation calculation system 8 creates calculation groups for one or more of countries 18 based on the received setup information from the system administrator (72). Each of the calculation groups includes one or more compensation types of the specific one of countries 18.

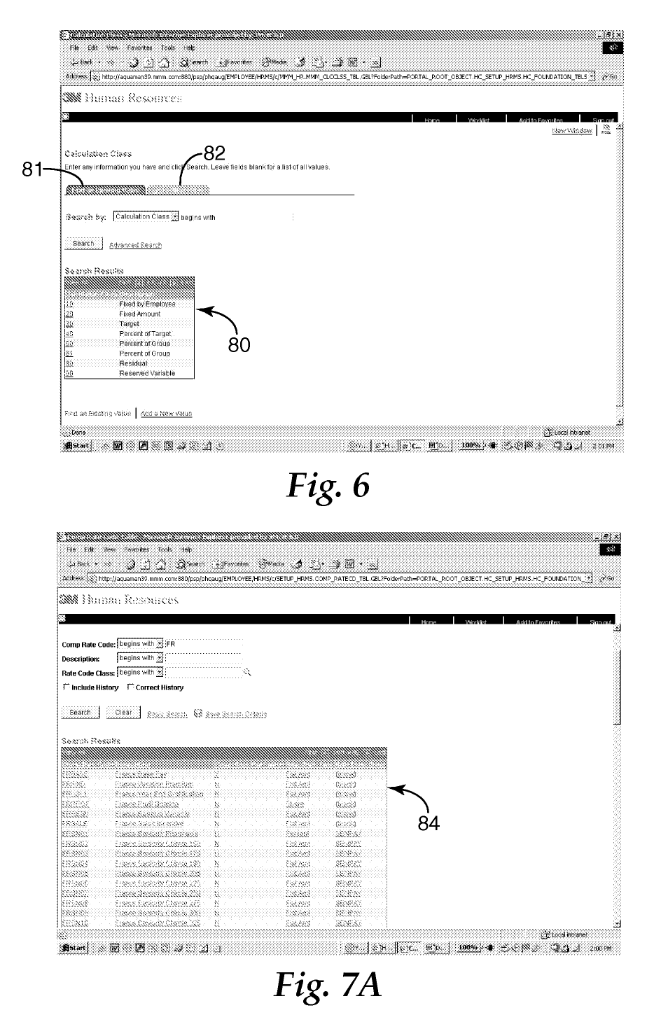

FIGS. 6-11 are exemplary screen shots of a user interface presented to a system administrator via a user device by user interface module 12. FIG. 6 is a screen shot of the user interface displaying a set of calculation classes 60 stored in calculation class database 26 within compensation rules database 16. Calculation classes 60 may be defined for all of the plurality of countries of the corporation. In the illustrated embodiment, the system administrator has selected the “find an existing value” tab 81 and the user interface is displaying existing values for the set of calculation classes 60. In other embodiments, the system administrator may select the “add a new value” tab 82 to define a new level within an existing calculation class of the set of calculation classes 60.

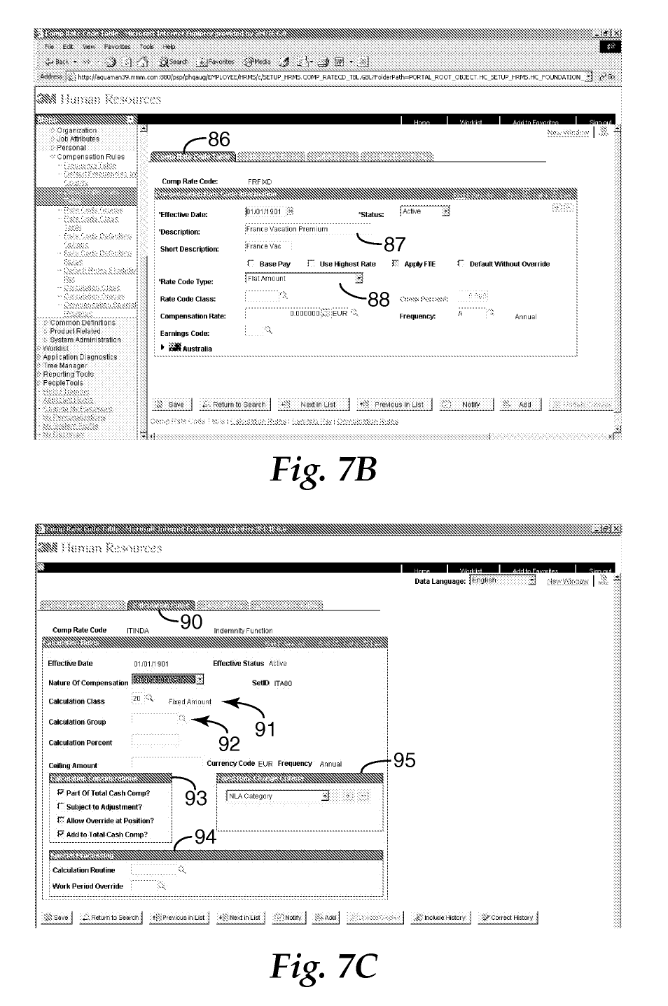

FIG. 7A is a screen shot of the user interface displaying a plurality of compensation types 84 stored in compensation type database 20 of a specific one of countries 18. In the illustrated embodiment, compensation types 84 comprise the ninety compensation types included in the set of compensation rules for France. FIG. 7B is a screen shot of the user interface displaying compensation type information for one of the plurality of compensation types 84. The system administrator has selected the “compensation rate code table” tab 86. In this case, the user interface displays a description 87 and a code type 88 of the selected one of compensation types 84. The system administrator may modify the description 87 and code type 88 to define the selected on of compensation types 84.

FIG. 7C is another screen shot of the user interface displaying compensation type information for one of the plurality of compensation types 84. The system administrator has selected the “calculation rules” tab 90. In this case, the user interface displays a calculation class 91 and a calculation group 92 (if applicable) of the selected one of compensation types 84. The system administrator may modify the calculation class 91 and the calculation group 92 to define the selected on of compensation types 84. In addition, the user interface displays a calculation considerations box 93 that enables the system administrator to specify whether the selected one of compensation types 84 is part of the total cash compensation amount, manually adjustable, and added to the total cash compensation amount. The user interface also displays a special processing box 94 that enables coding changes to be loaded from a user device and a fixed rate change criteria box 95 that enables a system administrator to select fixed rate information for the selected one of compensation types 84.

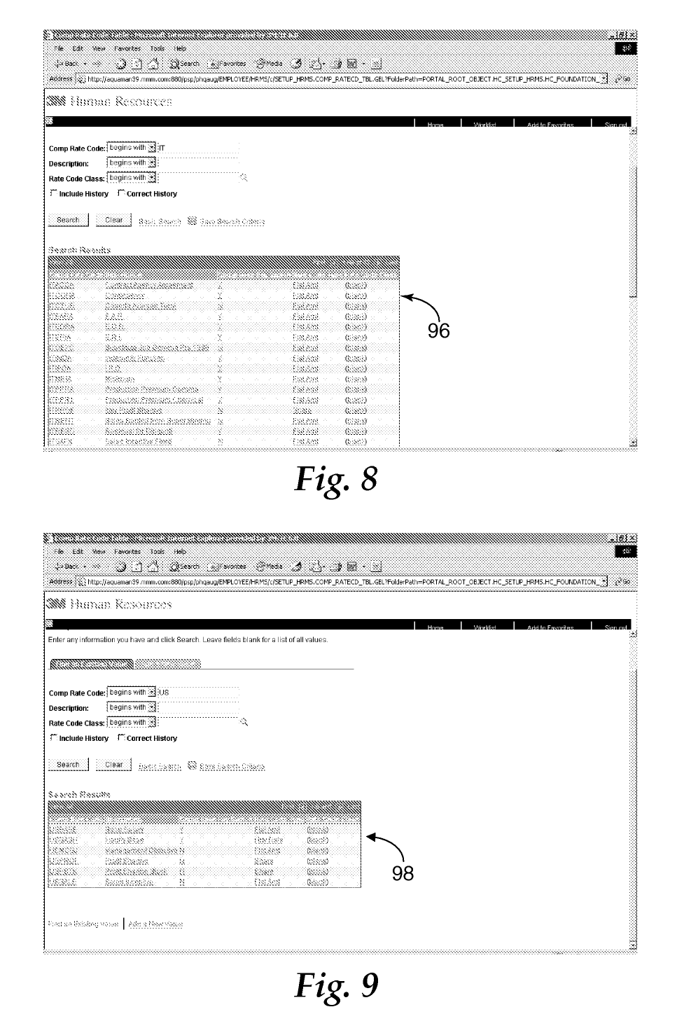

FIG. 8 is a screen shot of the user interface displaying a plurality of compensation types 96 stored in compensation type database 20 of a specific one of countries 18. In the illustrated embodiment, compensation types 96 comprise the forty-three compensation types included in the set of compensation rules for Italy.

FIG. 9 is a screen shot of the user interface displaying a plurality of compensation types 98 stored in compensation type database 20 of a specific one of countries 18. In the illustrated embodiment, compensation types 98 comprise the six compensation types included in the set of compensation rules for the United States of America.

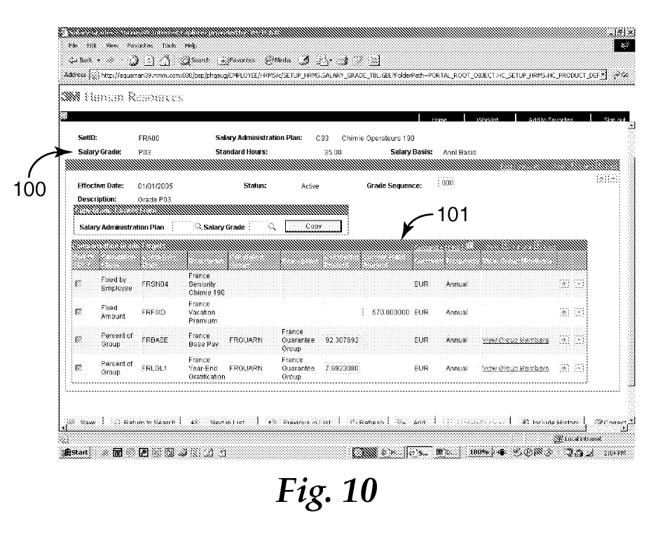

FIG. 10 is a screen shot of the user interface displaying a set of compensation types 101 assigned to a job grade 100 within the corporation. In this way, when an employee moves into job grade 100 within the corporation, calculation module 10 automatically applies the set of compensation types 101 to the employee.

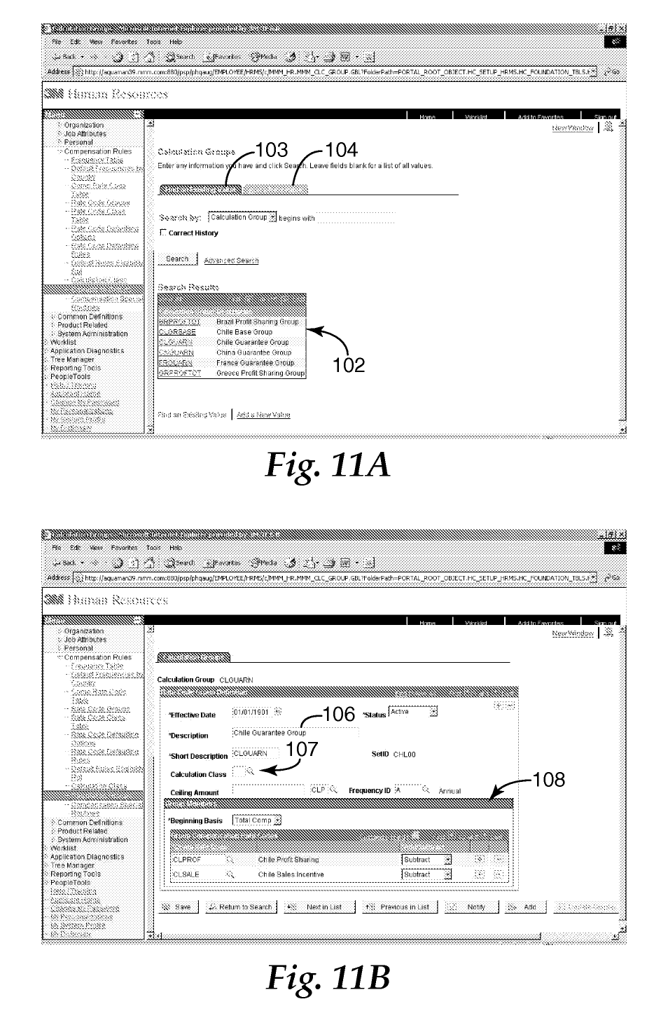

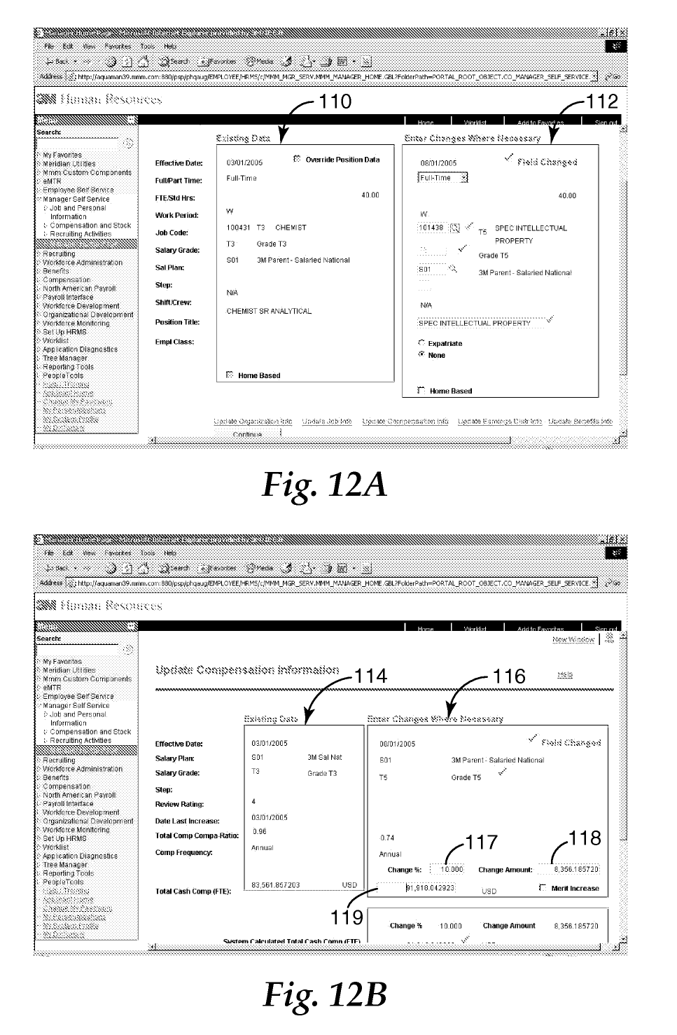

FIG. 11A is a screen shot of the user interface displaying compensation groups 102 stored in group database 24 of a specific one of countries 18. In the illustrated embodiment, the system administrator has selected the “find an existing value” tab 103 and the user interface is displaying existing compensation groups 102. In other embodiments, the system administrator may select the “add a new value” tab 104 to create a new compensation group for a specific one of countries 18.

FIG. 11B is a screen shot of the user interface displaying compensation group information for one of the compensation groups 102. In this case, the user interface displays a description 106 and a calculation class 107 of the selected one of compensation groups 102. The system administrator may modify the description 106 and calculation class 107 to define the selected one of compensation groups 102. The user interface also displays a group members box 108 that specifies one or more compensation types within the selected one of compensation groups 102.

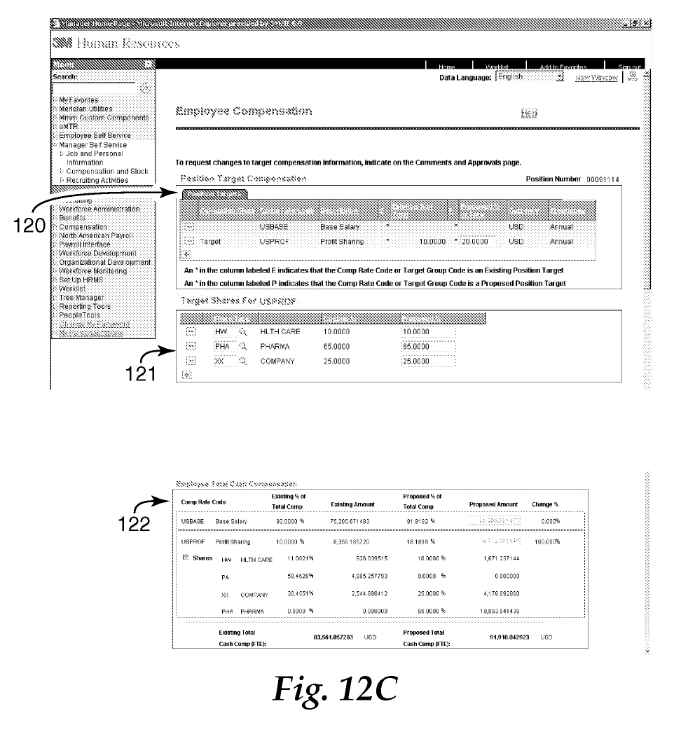

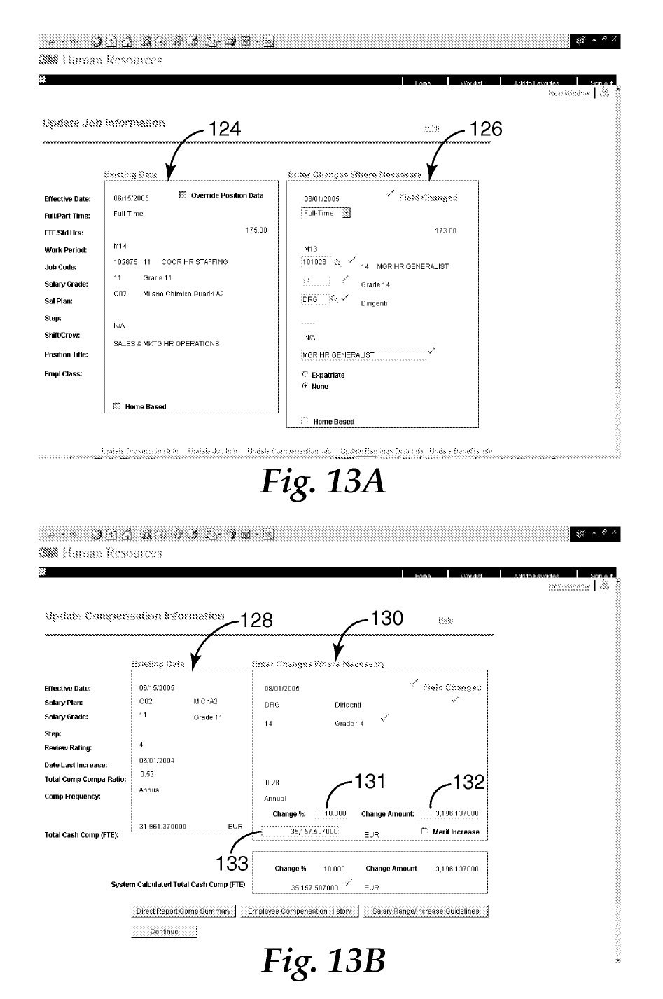

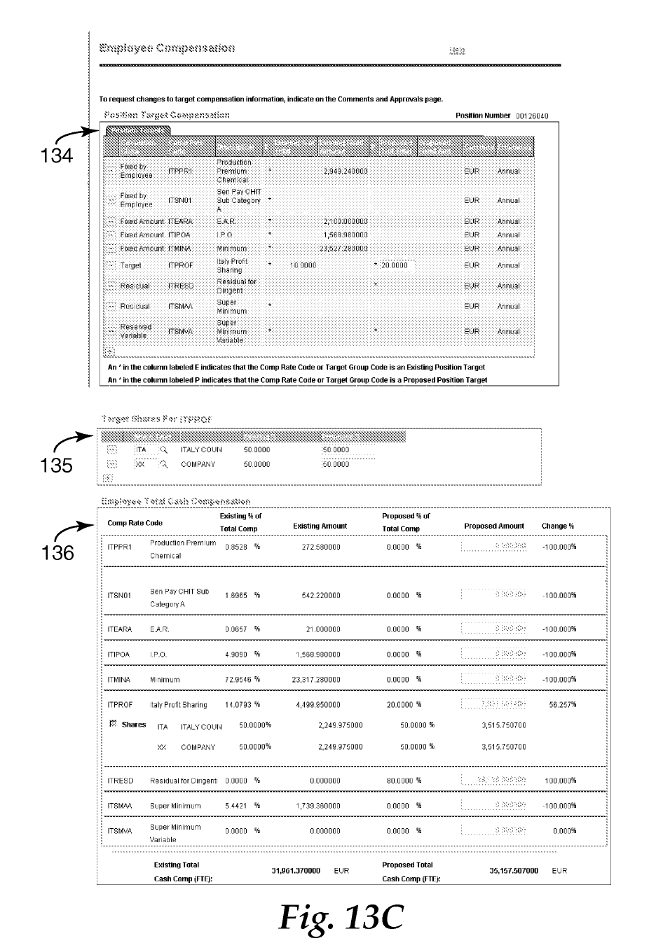

FIGS. 12 and 13 are exemplary screen shots of a user interface presented to a manager, supervisor or other self-service initiator via a user device by user interface module 12. FIG. 12A is a screen shot of the user interface displaying current profile information and a profile change request for an employee of the corporation within the United States of America. The user interface displays job information 110 and a job change request 112. The manager may enter a status, a job grade, a salary plan, and a position title of the employee into job change request 112 to modify job information 110 of the employee. FIG. 12B is a screen shot of the user interface further displaying the current profile information and the profile change request for the employee. The user interface displays compensation information 114 and a compensation change request 1 16. The manager may enter a change of a total cash compensation amount for the employee by entering a change percentage 117 or a change amount 118 from the existing total cash compensation amount specified in the compensation information 114. The manager may also enter a change of a total cash compensation amount for the employee by entering a new total cash compensation amount 119. In some cases, the change percentage 117, change amount 118, or new total cash compensation amount 19 may be associated with the job grade and/or the step within the job grade of the employee.

FIG. 12C is a screen shot of the user interface displaying compensation amounts for the employee. Calculation module 10 calculates the compensation allocation amounts based on the received profile change request for the employee and a set of compensation rules for the country of employment of the employee. The user interface displays the compensation types 120 applied to the employee based on at least one of a job grade, a step within the job grade, a salary plan, or position information of the employee. The user interface displays share based target allocation amounts 121 for compensation types 120 within a target calculation class. The user interface also displays compensation allocation amounts 122 for each of compensation types 120 and each of share based target allocation amounts 121. Compensation allocation amounts 122 add up to the total cash compensation amount specified in the profile change request for the employee.

FIG. 13A is a screen shot of the user interface displaying current profile information and a profile change request for an employee of the corporation within Italy. The user interface displays job information 124 and a job change request 126. The manager may enter a status, a job grade, a salary plan, and a position title of the employee to modify the profile information of the employee into job change request 126 to modify job information 124 of the employee. FIG. 13B is a screen shot of the user interface further displaying the profile information and the profile change request for the employee. The user interface displays compensation information 128 and a compensation change request 130. The manager may enter a change of a total cash compensation amount for the employee by entering a change percentage 131 or a change amount 132 from the existing total cash compensation amount specified in the compensation information 128. The manager may also enter a change of a total cash compensation amount for the employee by entering a new total cash compensation amount 133. In some cases, the change percentage 131, change amount 132, or new total cash compensation amount 133 may be associated with the job grade and the step within the job grade of the employee.

FIG. 13C is a screen shot of the user interface displaying compensation amounts for the employee. Calculation module 10 calculates the compensation allocation amounts based on the received profile change request for the employee and a set of compensation rules for the country of employment of the employee. The user interface displays the compensation types 134 applied to the employee based on the at least one of a job grade, a step within the job grade, a salary plan, or position information of the employee. The user interface displays share based target allocation amounts 135 for compensation types 134 within a target calculation class. The user interface also displays compensation allocation amounts 136 for each of compensation types 134 and each of share based target allocation amounts 135. In the illustrated embodiment, the compensation types applied to the employee based on the new job grade of the employee vary widely from the compensation types applied to employee based on the previous job grade of the employee. Compensation allocation amounts 136 add up to the total cash compensation amount specified in the profile change request for the employee.

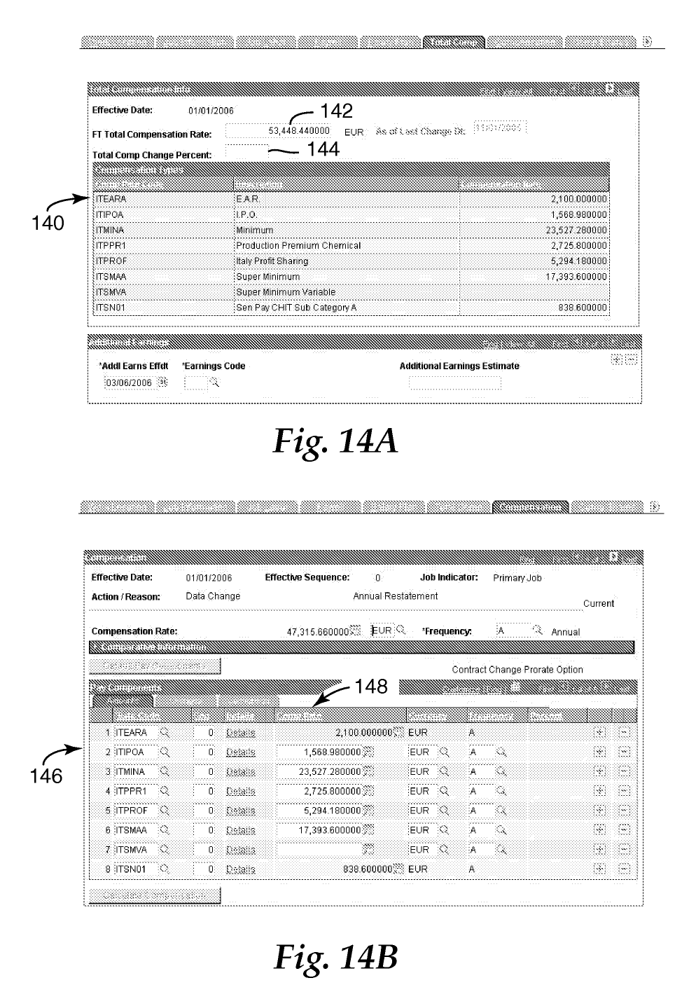

FIGS. 14A and 14B are exemplary screen shots of a user interface presented to a system administrator via a user device by user interface module 12. FIG. 14A is a screen shot of the user interface displaying compensation allocation amounts 140 for each of the compensation types applied to the employee. The system administrator may enter a change of a total cash compensation amount for the employee by entering a change percentage 144 from the existing total cash compensation amount. The system administrator may also enter a change of a total cash compensation amount for the employee by entering a new total cash compensation amount 142. In some cases, the change percentage 144 or new total cash compensation amount 142 may be associated with at least one of a job grade, a step within the job grade, a step within a job grade, a salary plan, or position information of the employee.

FIG. 14B is a screen shot of the user interface displaying compensation types 146 and compensation allocation amounts 148 for each of the compensation types 146. The system administrator may modify any of compensation types 146 for the employee. In addition, the system administrator may alter any of compensation allocation amounts 148 corresponding to compensation types 146. Altering compensation allocation amounts 148 in turn changes the total cash compensation amount for the employee and populates the change percentage from the previous total cash compensation amount.

Calculation module 10 may then calculate the compensation allocation amounts based on the change request entered by the system administrator of the total cash compensation amount for the employee. The user interface may display the compensation types applied to the employee and the corresponding compensation allocation amounts for each of the compensation types based on the new total cash compensation amount, substantially similar to FIGS. 12C and 13C.

Various implementations and embodiments of the invention have been described. Nevertheless, it is understood that various modifications can be made without departing from the invention. These and other embodiments are within the scope of the following claims.

1. A computer-implemented method comprising:
maintaining sets of compensation rules for a plurality of countries in a database for a corporation;
receiving a profile change request for an employee of the corporation;
retrieving a set of compensation rules from the database for the country of employment of the employee based on the profile change request; and
automatically calculating compensation amounts for the employee based on the profile change request and the set of compensation rules.

2. The method of claim 1, wherein receiving the profile change request comprises receiving changes to existing profile information for the employee.

3. The method of claim 1, wherein receiving the profile change request comprises receiving at least one of a job change request and a compensation change request for the employee, wherein the job change request specifies a new job grade for the employee, and wherein the compensation change request specifies a new total cash compensation amount and new compensation allocation amounts for the employee.

4. The method of claim 3, wherein the compensation change request specifies a change of the total cash compensation amount as at least one of a change percentage or a change amount from the existing total cash compensation amount, or a new total cash compensation amount.

5. The method of claim 1, wherein maintaining sets of compensation rules comprises:
maintaining a set of calculation classes for all of the plurality of countries; and
maintaining a plurality of compensation types for each of the plurality of countries.

6. The method of claim 5, further comprising selecting one or more of the plurality of compensation types from the retrieved set of compensation rules based on at least one of a job grade, a step within the job grade, a salary plan, or position information of the employee.

7. The method of claim 6, further comprising determining a calculation class from the set of calculation classes for each of the selected compensation types.

8. The method of claim 7, wherein calculating the compensation amounts comprises:
calculating a total cash compensation amount based on the profile change request; and
calculating compensation allocation amounts for each of the selected compensation types based on the total cash compensation amount and the determined calculation class.

9. The method of claim 6, wherein calculating the compensation allocation amounts comprises:
allocating borrowed compensation amounts to one or more fixed sales incentive compensation types selected from the retrieved set of compensation rules;
tracking the borrowed compensation amounts to create fixed sales incentives; and
adjusting the borrowed compensation amounts based on changes to a total compensation amount of the employee.

10. The method of claim 5, wherein maintaining the sets of compensation rules comprises maintaining a plurality of target classes for one or more of the plurality of countries, wherein at least one of the plurality of target classes includes one or more target allocation amounts that are percentages of a total cash compensation amount.

11. The method of claim 10, wherein at least one of the plurality of target classes comprises a share based target class, and wherein each of the target allocation amounts comprises a share within the share based target class.

12. The method of claim 10, wherein maintaining the sets of compensation rules comprises maintaining a plurality of percent of target classes for one or more of the plurality of countries, further comprising adding one or more percent of target allocation amounts together forms a percentage of the total cash compensation amount.

13. The method of claim 5, wherein maintaining the sets of compensation rules comprises maintaining a plurality of groups for one or more of the plurality of countries, wherein each of the plurality of groups includes one or more of the plurality of compensation types.

14. The method of claim 13, wherein each of the plurality of groups comprises two or more of the plurality of compensation types to be added together.

15. The method of claim 13, wherein each of the plurality of groups comprises one or more of the plurality of compensation types to be subtracted from a total cash compensation amount for the employee.

16. The method of claim 5, wherein the set of calculation classes comprises a blank class, a fixed by employee class, a fixed class, a target class, a percent of target class, a percent of group class, a residual class, and a reserved variable class.

17. The method of claim 1, wherein calculating the compensation amounts comprises:
calculating a total cash compensation amount based on the profile change request; and
calculating compensation allocation amounts based on the total cash compensation amount and the retrieved set of compensation rules.

18. The method of claim 17, wherein calculating the compensation allocation amounts comprises:
detecting a calculation type for each of the compensation types with a blank calculation class and assigning a non-blank calculation classes to the compensation type;
allocating fixed compensation amounts;
allocating target class compensation amounts that are percentages of the total cash compensation amount;
allocating percent of target class compensation amounts that are percentages of the target class compensation amounts;
allocating percent of group compensation amounts that are percentages of a sum of compensation amounts for two or more compensation types of the retrieved compensation rules;
allocating residual allocation amounts; and
allocating reserved variable allocation amounts.

19. The method of claim 17, further comprising:
summing the compensation allocation amounts;
comparing the sum to the total cash compensation amount; and
altering the total cash compensation amount when the sum is not equal to the total cash compensation amount.

20. The method of claim 17, further comprising:
comparing one or more new guaranteed compensation allocation amounts to one or more existing guaranteed compensation allocation amounts; and
altering the one or more new compensation allocation amounts when the new guaranteed compensation allocation amounts are less than the existing guaranteed compensation allocation amounts.

21. A computer-implemented system comprising:
a compensation rules database that maintains compensation rules for a plurality of countries for a corporation;
a user interface module that presents a user interface to a user and receives a profile change request for an employee of the corporation from the user via the user interface; and
a calculation module that retrieves a set of compensation rules from the database for the country of employment of the employee based on the profile change request, and automatically calculates a compensation amount for the employee based on the profile change request and the set of compensation rules.

22. The system of claim 21, wherein the received profile change request comprises at least one of a job change request and a compensation change request for the employee, wherein the job change request specifies a new job grade for the employee, and wherein the compensation change request specifies a new total cash compensation amount and new compensation allocation amounts for the employee.

23. The system of claim 21, wherein the compensation rules database comprises a calculation class database the maintains a set of calculation classes for all of the plurality of countries and a compensation type database that maintains a plurality of compensation types for each of the plurality of countries.

24. The system of claim 23, wherein the calculation module selects one or more of the plurality of compensation types from the compensation type database of the retrieved set of compensation rules based on at least one of a job grade, a step within the job grade, a salary plan, or position information of the employee.

25. The system of claim 23, wherein the calculation module determines a calculation class from the calculation class database for each of the selected compensation types.

26. The system of claim 25, wherein the calculation module calculates a total cash compensation amount based on the profile change request, and calculates compensation allocation amounts for each of the selected compensation types based on the total cash compensation amount and the determined calculation class.

27. The system of claim 23, wherein the compensation rules database comprises a target database that maintains a plurality of target classes for one or more of the plurality of countries, wherein at least one of the plurality of target classes includes one or more target allocation amounts that are percentages of a total cash compensation amount.

28. The system of claim 23, wherein the compensation rules database comprises a group database that maintains a plurality of groups for one or more of the plurality of countries, wherein each of the plurality of groups includes one or more of the plurality of compensation types.

29. The system of claim 23, wherein the set of calculation classes comprises a blank class, a fixed by employee class, a fixed class, a target class, a percent of target class, a percent of group class, a residual class, and a reserved variable class.

30. The system of claim 21, wherein the calculation module calculates a total cash compensation amount based on the profile change request, and calculates compensation allocation amounts based on the total cash compensation amount and the retrieved set of compensation rules.

31. A computer-implemented method comprising:
receiving compensation rule setup information for a plurality of countries;
establishing sets of compensation rules for the plurality of countries based on the setup information; and
maintaining the sets of compensation rules for the plurality of countries in a database for a corporation.

32. The method of claim 31, wherein establishing the sets of compensation rules comprises defining a plurality of compensation types for each of the plurality of countries.

33. The method of claim 32, wherein establishing the sets of compensation rules comprises creating a set of calculation classes for all of the plurality of countries that specifies calculation methods for the compensation types.

34. The method of claim 32, wherein establishing the sets of compensation rules comprises assigning one or more of the compensation types to each of a plurality of job grades, steps within the job grades, salary plans, or position information in the corporation.

35. The method of claim 31, wherein establishing the sets of compensation rules comprises defining a plurality of target classes for one or more of the plurality of countries and defining target allocation amounts that are percentages of a total cash compensation amount for at least one of the plurality of target classes.

36. The method of claim 31, wherein establishing the sets of compensation rules comprises creating a plurality of groups for one or more of the plurality of countries, wherein each of the plurality of groups includes one or more of the compensation types.

37. The method of claim 32, further comprising receiving coding changes to the sets of compensation rules.

38. A computer-implemented method comprising:
receiving a profile change request for an employee of a corporation;
automatically calculating a total cash compensation amount for the employee based on the profile change request; and
automatically calculating compensation allocation amounts for the employee based on the total cash compensation amount and a set of compensation rules for a country of employment of the employee.

39. The method of claim 38 comprising:
maintaining sets of compensation rules for a plurality of countries in a database for a corporation; and
retrieving the set of compensation rules from the database for the country of employment of the employee based on the profile change request.

40. The method of claim 39, wherein maintaining sets of compensation rules comprises:
maintaining a set of calculation classes for all of the plurality of countries; and
maintaining a plurality of compensation types for each of the plurality of countries.

41. The method of claim 40, further comprising:
selecting one or more of the plurality of compensation types from the retrieved set of compensation rules based on at least one of a job grade, a step within the job grade, a salary plan, or position information of the employee; and
determining a calculation class from the set of calculation classes for each of the selected compensation types, wherein calculating the compensation allocation amounts comprises calculating compensation allocation amounts for each of the selected compensation types based on the total cash compensation amount and the determined calculation class.

42. The method of claim 40, wherein the set of calculation classes comprises a blank class, a fixed by employee class, a fixed class, a target class, a percent of target class, a percent of group class, a residual class, and a reserved variable class.

43. The method of claim 40, wherein maintaining the sets of compensation rules comprises maintaining a plurality of target classes for one or more of the plurality of countries, wherein at least one of the plurality of target classes includes one or more target allocation amounts that are percentages of a total cash compensation amount.

44. The method of claim 40, wherein maintaining the sets of compensation rules comprises maintaining a plurality of groups for one or more of the plurality of countries, wherein each of the plurality of groups includes one or more of the plurality of compensation types.

45. The method of claim 39, wherein calculating the compensation allocation amounts comprises:
detecting a calculation type for each of the compensation types with a blank calculation class and assigning a non-blank calculation classes to the compensation type;
allocating fixed compensation amounts;
allocating target class compensation amounts that are percentages of the total cash compensation amount;
allocating percent of target class compensation amounts that are percentages of the target class compensation amounts;
allocating percent of group compensation amounts that are percentages of a sum of compensation amounts for two or more compensation types of the retrieved compensation rules;
allocating residual allocation amounts; and
allocating reserved variable allocation amounts.

46. A computer-implemented system comprising:
a user interface module that presents a user interface to a user and receives a profile change request for an employee of a corporation from the user via the user interface; and
a calculation module that automatically calculates a total cash compensation amount for the employee based on the profile change request, and automatically calculates compensation allocation amounts for the employee based on the total cash compensation amount and a set of compensation rules for a country of employment of the employee.

47. The system of claim 46, further comprising a compensation rules database that maintains compensation rules for a plurality of countries for a corporation, wherein the calculation module retrieves the set of compensation rules from the database for the country of employment of the employee based on the profile change request.

48. The system of claim 47, wherein the compensation rules database comprises a calculation class database the maintains a set of calculation classes for all of the plurality of countries and a compensation type database that maintains a plurality of compensation types for each of the plurality of countries.

49. The system of claim 48, wherein the calculation module:
selects one or more of the plurality of compensation types from the compensation type database of the retrieved set of compensation rules based on at least one of a job grade, a step within the job grade, a salary plan, or position information of the employee.; and
determines a calculation class from the calculation class database for each of the selected compensation types, wherein the calculation module calculates the compensation allocation amounts for each of the selected compensation types based on the determined calculation class.

50. The system of claim 48, wherein the set of calculation classes comprises a blank class, a fixed by employee class, a fixed class, a target class, a percent of target class, a percent of group class, a residual class, and a reserved variable class.

51. The system of claim 48, wherein the compensation rules database comprises a target database that maintains a plurality of target classes for one or more of the plurality of countries, wherein at least one of the plurality of target classes includes one or more target allocation amounts that are percentages of a total cash compensation amount.

52. The system of claim 48, wherein the compensation rules database comprises a group database that maintains a plurality of groups for one or more of the plurality of countries, wherein each of the plurality of groups includes one or more of the plurality of compensation types.
